(19) United States
(12) Patent Application Publication
(10) Pub. No.: US 2013/0194390 A1
(43) Pub. Date: Aug. 1, 2013

(54) DISTANCE MEASURING DEVICE

(71) Applicant: HITACHI, LTD., Tokyo (JP)

(72) Inventor: Shinichiro HIROOKA, Fujisawa-shi (JP)

(73) Assignee: HITACHI, LTD., Tokyo (JP)

(21) Appl. No.: 13/748,966

(22) Filed: Jan. 24, 2013

(30) Foreign Application Priority Data
Jan. 30, 2012 (JP) 2012-016084

(51) Int. Cl. G01C 11/02

(52) U.S. Cl. CPC G01C 11/025
USPC 348/47

(57) ABSTRACT

A distance measuring device with a patterned-infrared-light irradiator, a near-infrared-light camera, a visible-light camera, a first imaging section having spectral response characteristics in a wavelength band of visible light and a predetermined wavelength band of invisible light a second imaging section having spectral response characteristics in the wavelength band of the visible light, an invisible-light projector for projecting the invisible light of the predetermined wavelength band in an angle-of-view range of the first imaging section; an invisible-light-aided distance computing section adapted to conduct image processing of an image formed by and output from the first imaging section, a stereo distance computing section adapted to conduct stereo image processing of both the image formed by and output from the first imaging section, and an image formed by and output from the second imaging section, and a distance computation controller adapted to control computation conditions used for the invisible-light-aided distance computing section.

### CLAIMS OF PRIORITY

The present application claims priority from Japanese patent application serial no. JP2012-016084, filed on Jan. 30, 2012, the content of which is hereby incorporated by reference into this application.

### BACKGROUND OF THE INVENTION

The present invention relates to a distance measuring device provided with a distance measuring function of a patterned-infrared-light projection scheme and a distance measuring function of a stereo scheme using a plurality of camera images.

Techniques relating to the present invention include one disclosed in Japanese Patent No. 4452951, the technique of which is intended to provide a distance image generator capable of achieving the generation of highly accurate distance images without increasing the dimensions and costs of the device. The image generator has the following configuration to implement the object of the technique. A camera 10 includes two imaging sections, PA and PB, from which the image generator acquires images formed by light of a visible wavelength band and then generates a distance image A from these images by means of stereo matching. At the same time, the imaging section PB can also acquire an image formed by infrared light. This infrared image, based upon the infrared light that has reflected after being irradiated from an infrared light irradiating section 18 onto a target subject, is acquired and a distance image B is generated using a time-of-flight (TOF) method. A shortage of distance data in the number of pixels in the distance image A is compensated for by interpolation with the distance data that the distance image B contains.

With the improvement of hardware performance and the expansion of diverse needs, a variety of techniques for determining a geometry of a target subject as well as a three-dimensional distance thereto, from image information, are being researched or are about to be commercialized. Of these techniques, an active type of distance measuring methodology, whereas it features a relatively short calculation time and highly accurate distance measurement with robustness with respect to a shape and texture of subjects, has a problem in that accurate distance information may not be obtained for a distant subject for whom or which infrared light attenuates, or for a black-projected or other subjects that absorb infrared light. Such an active type of distance measuring methodology is represented by the TOF scheme for calculating the distance to the subject by use of information such as a time required for emitted infrared light to be imaged onto a sensor after being reflected from the subject, and/or a phase difference of the reflected light with respect to the emitted light, or a structured-light pattern projection scheme for calculating the distance to the subject from how patterned infrared light of a specific pattern configuration actually looks when projected and irradiated onto the subject. In contrast, the stereo type of distance measuring methodology, in which images of the same subject are acquired with a plurality of cameras and information on the distance to the subject is obtained from a difference between the camera images in terms of the way the subject looks, does not require a special light source, but has problems at least in that accurate distance information is not likely to be obtainable for a texture-less subject and in that calculation costs associated with image processing tend to increase with distance accuracy.

Japanese Patent No. 4452951 also proposes a second method, in which a plurality of cameras and infrared light irradiation devices are provided and distance measurement of the TOF scheme and distance measurement of the stereo scheme are combined. The second method applies TOF-based distance measurement to a target subject not enabling the distance measurement of the stereo scheme, and after the TOF-based distance measurement, interpolates the TOF-measured distance information, thus integrating the two sets of distance information and hence preventing a lack of distance information from occurring. However, since the second method employs a device configuration including a camera capable of imaging light of a near-infrared wavelength band with the TOF scheme, and a camera capable of imaging only light of a visible wavelength band with the stereo scheme, a need arises to provide at least a third camera or to include, in one of the existing two cameras, optics that enables mounting and removal of an infrared-light cutoff filter. Providing these measures will lead to an increase in part costs. The calculation time required is also estimated to increase very significantly, since the configuration requires independent calculation of distance information using the TOF scheme and the stereo scheme each.

The present invention provides a high-performance distance measuring device configured to solve the above problems and implement distance information acquisition at minimum part costs and minimum computing costs.

### SUMMARY OF THE INVENTION

Some of typical aspects of the invention disclosed herein are outlined below.

(1) A distance measuring device includes: a first imaging section having spectral response characteristics in a wavelength band of visible light and in a predetermined wavelength band of invisible light; a second imaging section having spectral response characteristics in the wavelength band of visible light, the second imaging means having no spectral response characteristics in the predetermined wavelength band of invisible light; an invisible-light projector for projecting the invisible light of the predetermined wavelength band in an angle-of-view range of the first imaging section; an invisible-light-aided distance computation section adapted to conduct image processing of an image formed by and output from the first imaging section, then compute a first distance to a target subject on the basis of information contained in the invisible light of the predetermined wavelength band that is projected onto the subject detected from the image, and output the first distance information; a stereo distance computation section adapted to conduct stereo image processing of both the image formed by and output from the first imaging section and an image formed by and output from the second imaging section, then compute a second distance to the subject, and output the second distance information; and a distance computation control section adapted to control computation conditions used for the invisible-light-aided distance computation section and the stereo distance computation section to conduct the respective computations.

(2) Another distance measuring device includes: a first imaging section having spectral response characteristics in a wavelength band of visible light and in a predetermined wavelength band of invisible light; a second imaging section having spectral response characteristics in the wavelength band of the visible light, the second imaging means having no spectral response characteristics in the predetermined wavelength band of the invisible light; and a stereo distance computation section adapted to conduct stereo image processing of both an image which includes components of the predetermined wavelength band of the invisible light, the image being formed by and output from the first imaging section and an image which does not include components of the predetermined wavelength band of the invisible light, the image being formed by and output from the second imaging section, then compute a distance to a target subject, and output the distance information.

(3) Yet another distance measuring device includes: a first imaging section having spectral response characteristics in a wavelength band of visible light and in a predetermined wavelength band of invisible light; a second imaging section having spectral response characteristics in the wavelength band of the visible light, the second imaging means having no spectral response characteristics in the predetermined wavelength band of the invisible light; an invisible-light projector for projecting the invisible light of the predetermined wavelength band in an angle-of-view range of the first imaging section; an invisible-light-aided distance computation section adapted to conduct image processing of an image formed by and output from the first imaging section, then after detecting information contained in the invisible light of the predetermined wavelength band that is projected onto a target subject in the image, compute a first distance to the subject, and output the first distance information; a stereo distance computation section adapted to conduct stereo image processing of both the image formed by and output from the first imaging section and an image formed by and output from the second imaging section, then compute a second distance to the subject, and output the second distance information; a distance computation controller adapted to control computation conditions used for the invisible-light-aided distance computation section and the stereo distance computation section to conduct the respective computations; and a timing controller that controls a period during which the invisible-light projector projects the invisible light, an imaging by the first imaging section, acquired-image output timing thereof, imaging by the second imaging section, acquired-image output timing thereof, distance computation timing of the invisible-light-aided distance computation section, and distance computation timing of the stereo distance computation section; wherein, under the timing control of the timing controller, the invisible-light projector projects the invisible light in predetermined timing, the invisible-light-aided distance computation section conducts a distance computation process using the image that the first imaging section acquires and outputs in the timing that the invisible light is being projected, and the stereo distance computation section conducts a distance computation process using the images that both of the first imaging section and the second imaging section acquire and output in the timing that the invisible light is not being projected.

(4) A further distance measuring device includes: a first imaging section having spectral response characteristics in a wavelength band of visible light and in a predetermined wavelength band of invisible light; a second imaging section having spectral response characteristics in the wavelength band of the visible light, the second imaging means having no spectral response characteristics in the predetermined wavelength band of the invisible light; an invisible-light-aided distance computation section adapted to conduct image processing of an image formed by and output from the first imaging section, then after detecting information contained in the invisible light of the predetermined wavelength band that is projected onto a target subject in the image, compute a first distance to the subject, and output the first distance information; a stereo distance computation section adapted to conduct stereo image processing of both the image formed by and output from the first imaging section and an image formed by and output from the second imaging section, then compute a second distance to the subject, and output the second distance information; a distance computation controller adapted to control computation conditions used for the invisible-light-aided distance computation section and the stereo distance computation section to conduct the respective computations; and a distance computation information calibrator that calculates calibration information that the patterned-light-aided distance computation section and the stereo distance computation section are to use for computing distance information, and stores the calculated calibration information; wherein, the distance computation controller sets a distance measuring range of the invisible-light-aided distance computation section and a distance measuring range of the stereo distance computation section so that the distance measuring ranges partly overlap; and wherein, on a basis of the two sets of distance information obtained during the computations in the overlapping distance measuring ranges by the patterned-light-aided distance computation section and the stereo distance computation section, the distance computation information calibrator calculates the calibration information that either the patterned-light-aided distance computation section or the stereo distance computation section is to use for computing the distance information, and stores the calculated calibration information.

As outlined above, the present invention provides a high-performance distance measuring device that can implement distance information acquisition at minimum part costs and minimum computing costs.

### BRIEF DESCRIPTION OF THE DRAWINGS

FIG. 1 is a first schematic diagram of a distance measuring device according to a first embodiment of the present invention;

FIG. 2 is a diagram showing an example of a distance computation control process in the distance measuring device according to the first embodiment of the present invention;

FIG. 3 is a diagram showing an example of a distance computation control process relating to patterned-light-aided distance computation in the distance measuring device according to the first embodiment of the present invention;

FIG. 4 is a diagram showing an example of a distance computation control process relating to stereo distance computation in the distance measuring device according to the first embodiment of the present invention;

FIG. 5 is a diagram showing an example of a distance information integration sequence in the distance measuring device according to the first embodiment of the present invention;

FIG. 6 is a diagram showing another example of the distance computation control and distance information integration in the distance measuring device according to the first embodiment of the present invention;

FIG. 7 is a first diagram showing a stereo distance computation process in the distance measuring device according to the first embodiment of the present invention;

FIG. 8 is a second diagram showing another example of a stereo distance computation process in the distance measuring device according to the first embodiment of the present invention;

FIG. 9 is a second schematic diagram showing another example of a distance measuring device according to the first embodiment of the present invention;

FIG. 10 is a diagram showing a sensitivity correction process in the distance measuring device according to the first embodiment of the present invention;

FIG. 11 is a diagram showing an example of a distance computation control sequence in the distance measuring device according to the first embodiment of the present invention;

FIG. 12 is a schematic diagram of a distance measuring device according to a second embodiment of the present invention;

FIG. 13 is a diagram showing an example of a timing control process in the distance measuring device according to the second embodiment of the present invention;

FIG. 14 is a diagram showing an example of a distance computation control process in the distance measuring device according to the second embodiment of the present invention;

FIG. 15 is a schematic diagram of a distance measuring device according to a third embodiment of the present invention;

FIG. 16 is a schematic diagram of a distance measuring device according to a fourth embodiment of the present invention;

FIG. 17 is a diagram showing an example of a distance computation information calibration sequence in the distance measuring device according to the fourth embodiment of the present invention;

FIG. 18 is a schematic diagram of a distance measuring device according to a fifth embodiment of the present invention; and

FIG. 19 is a schematic diagram of a distance measuring device according to a sixth embodiment of the present invention.

### DESCRIPTION OF THE PREFERRED EMBODIMENTS

Hereunder, embodiments of the present invention will be described using the accompanying drawings as appropriate.

### First Embodiment

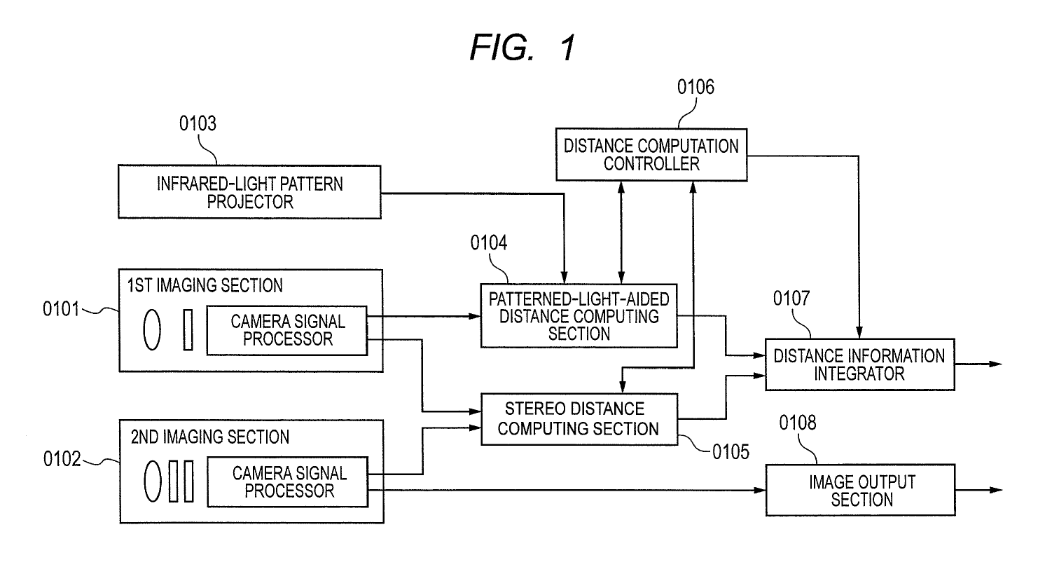

FIG. 1 is a first schematic diagram of a distance measuring device according to a first embodiment of the present invention. Referring to FIG. 1, the distance measuring device includes a first imaging section 0101, a second imaging section 0102, a patterned-infrared-light projector 0103, a patterned-light-aided distance computing section 0104, a stereo distance computing section 0105, a distance computation controller 0106, a distance information integrator 0107, and an image output section 0108.

The imaging section 0101 of the distance measuring device shown in FIG. 1 includes a lens group with a zoom lens and a focusing lens. The imaging section 0101 also includes as an iris, a shutter, an image pickup element such as a CCD or CMOS circuit, a CDS or AGC circuit, an A-D converter, etc. combined as appropriate. The imaging section 0101, after its image pickup element has detected incoming light and formed an optical image, converts the image into an electrical signal, then conducts camera signal processing such as noise reduction, edge enhancement, and gamma processing, and outputs the signal as an image signal. The imaging section 0102 likewise includes a lens group with a zoom lens and a focusing lens. The imaging section 0102 also includes an iris, a shutter, an infrared-light cutoff filter, an image pickup element such as a CCD or CMOS circuit, a CDS or AGC circuit, an A-D converter, etc. combined as appropriate. The imaging section 0102, after its image pickup element has detected incoming light and formed an optical image, converts the image into an electrical signal, then conducts camera signal processing such as noise reduction, edge enhancement, and gamma processing, and outputs the signal as an image signal. A characteristic difference between the imaging section 0101 and the imaging section 0102 is whether an infrared-light cutoff filter is present. The imaging section 0101 does not have an infrared-light cutoff filter, and the image pickup element thereof has spectral response characteristics in wavelength bands of near-infrared light in addition to visible light, and can acquire an image of a target subject which includes near-infrared components. The imaging section 0102, on the other hand, does have an infrared-light cutoff filter, and the image pickup element thereof does not have spectral response characteristics in the wavelength band of near-infrared light and can acquire an image of a target subject free of near-infrared components. All constituent elements other than the infrared-light cutoff filter may be common between the imaging sections 0101 and 0102, and characteristics factors such as an angle of view and focal length may be different according to requirements. In addition, the image pickup element of the imaging section 0102 may be configured to include, for example, a color filter of primary colors or complementary colors, and to conduct camera signal processing that includes color generation, and output a color image signal.

The patterned-infrared-light projector 0103 projects patterned infrared light so that the pattern is reproduced within an angle-of-view range of the imaging section 0101. The patterned-infrared-light projector 0103 can be, for example, either a projector adapted to irradiate a patterned two-dimensional image with light of an infrared wavelength band, a laser light source with a diffuser, or a laser light source with a controller adapted to scan in timebase mode in both horizontal and vertical directions. Additionally, the infrared light pattern can be, for example, either a grid pattern or any other such repetitive pattern as of horizontal or vertical bars, an encoded pattern placed as a marker consisting of a combination of points or squares arranged at predetermined discrete positions. The imaging section 0101 and the patterned-infrared-light projector 0103 need to be placed at precalibrated and known positions. Preferably, however, the imaging section 0101 and the patterned-infrared-light projector 0103 are arranged to have respective optical axes parallel to each other as far as possible, to be as short as possible in placement spatial interval, and to match between a projection angle of the infrared light pattern and the angle-of-view of the imaging section 0101. The pattern will then be detectable more accurately from the image that the imaging section 0101 has acquired. The imaging section 0101 is desirably placed at a position at least closer to the patterned-infrared-light projector 0103 than to the imaging section 0102.

The patterned-light-aided distance computing section 0104 conducts image processing to detect, from the image that the imaging section 0101 acquired when the patterned-infrared-light projector 0103 projected the patterned infrared light, the pattern that is reproduced on that image after reflection of the light from the subject. After that, the patterned-light-aided distance computing section 0104 computes a distance to the subject, from information contained in the detected pattern. An existing method of projecting patterned light can be used to detect a shape of the patterned light emitted, to detect the pattern from the image acquired, and to compute the distance to the subject from the pattern detected. An example of projection using an encoded pattern is described below. The infrared-light pattern projector 0103 provides a two-dimensional light pattern having horizontal or vertical coordinates encoded beforehand as a specific marker of the patterned light to be projected, and projects the patterned light onto the subject. The patterned-light-aided distance computing section 0104 conducts a feature point detection process, a visual-point conversion process, a pattern-matching process, and the like, for each of small regions in the image acquired by the imaging section 0101, and detects the marker that is reproduced in each small region. Decoding the marker provides association between a position of the marker in the projected light pattern and that of the marker reproduced in the acquired image, and the association therefore allows the calculation of the distance to the subject, based upon the principles of triangulation. Smoothing and/or outlier removal may be conducted upon obtained distance information with reference being made to information relating to a spatial direction and a timebase direction. Interpolation of missing distance information and improvement of accuracy will then be achieved. Alternatively, execution results on a matching process for pattern detection, or a correlation with peripheral distance information may be output as assumed accuracy, that is, an evaluation value, of the calculated distance.

The stereo distance computing section 0105 conducts stereo image processing based upon the images output from the first imaging section 0101 and the second imaging section 0102, and then computes and outputs distance information and reliability thereof. The types of stereo image processing by the stereo distance computing section 0105 include a variety of processes. Examples are: a brightness-generating process for generating brightness information from a color image; a sensitivity-correcting process for imaging sections; a calibration process such as lens distortion correction, inter-image scaling factor correction, or paralleling; preprocessing such as low-pass filtering for noise reduction; feature quantity extraction such as edge detection; stereo matching intended to search for corresponding points between stereo images within a predetermined search range by using a block-matching process for a normalized cross-correlation, a differential absolute data sum, an increment sign correlation, or the like, and/or various other correlation arithmetic processes, and thereby to acquire parallax information; post-processing that removes singular points by rank-filtering, labeling, or the like; distance calculation for computing distance information using parallax information; and so on. The information obtained in the course of processing, for example, the evaluation value or parallax information obtained during stereo matching, a distribution of evaluation values in the search region, or the like may be output. The sensitivity obtained from the information of whether the imaging section has spectral sensitivity in the infrared wavelength band, is likely to significantly differ between stereo images, for which reason, feature quantities of edge components, for example, may be detected and then inter-image stereo matching between the feature quantities may take place to enable stable distance measurement even when the difference in sensitivity exists.

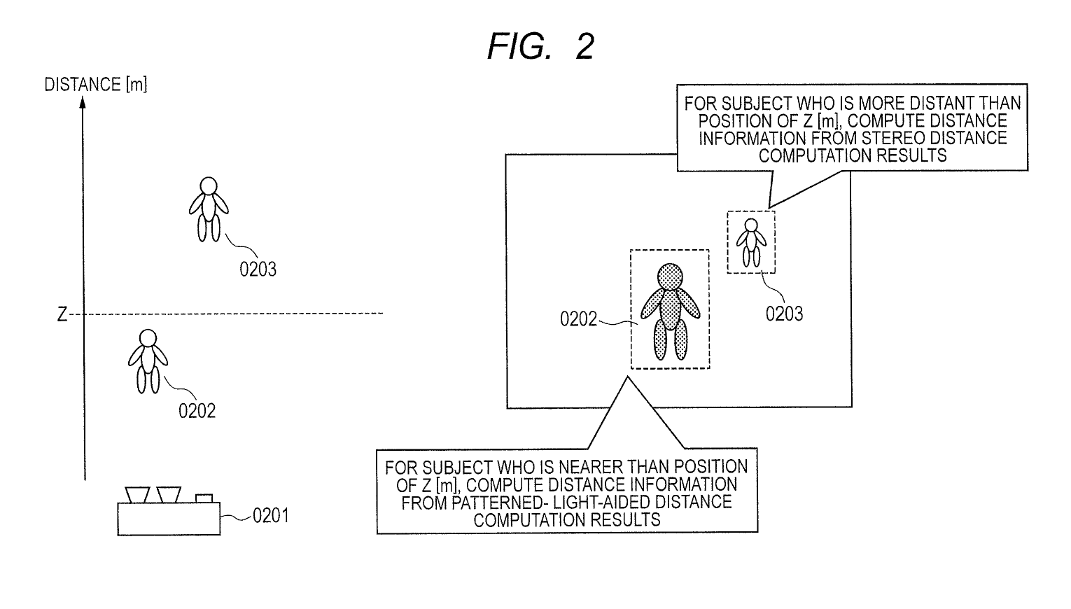

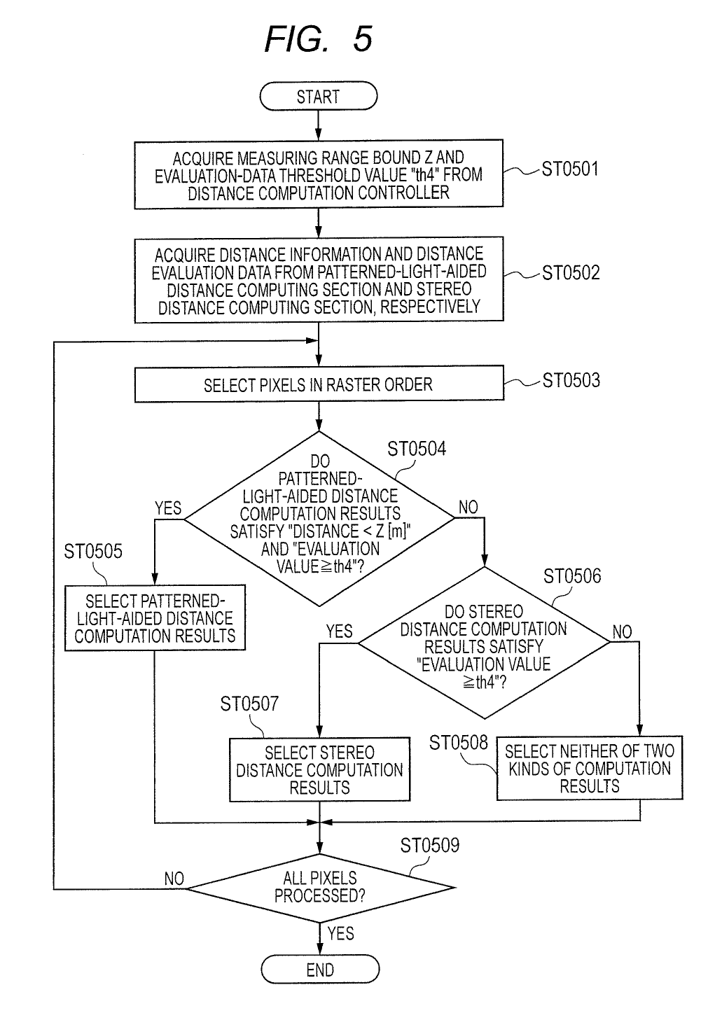

The distance computation controller 0106 sets up and outputs distance computation conditions as control information necessary for the patterned-light-aided distance computing section 0104 and the stereo distance computing section 0105 to perform distance computations. Examples of such control information include determination threshold values that the patterned-light-aided distance computing section 0104 uses to detect the pattern, and the search range where the stereo distance computing section 0105 searches for corresponding points between the stereo images. Further detailed operational actions are described later using FIGS. 2, 3, and 4. The distance information integrator 0107 integrates the respective sets of distance information that the patterned-light-aided distance computing section 0104 and the stereo distance computing section 0105 have output, and then outputs the distance information as one set of distance information. The integration of the distance information is described in further detail later herein using FIG. 5. The image output section 0108 converts the image output from the imaging section 0102, into an image format suited to desired output image standards or specifications, and outputs the new image of that image format to an external apparatus not shown, such as a monitor or a personal computer (PC). Where necessary, the image may be encoded and then output as a compressed image. Thus the distance measuring device can generate and output acquired images under its simplified configuration, the device also becoming able to generate highly accurate distance information by combining the patterned-light projection method and the stereo method, and output the distance information.

The patterned-light-aided distance computation process in the patterned-light-aided distance computing section 0104, the stereo distance computation process in the stereo distance computing section 0105, the distance computation control process in the distance computation controller 0106, and the distance information integration process in the distance information integrator 0107 are conducted by an internal microcomputer or dedicated LSI of the camera, software in the PC, a graphics processing unit (GPU) in the PC, etc. The distance measuring device may be configured to assign part of processing to the dedicated LSI or the accompanying microcomputer, and assign a remainder of processing to the PC.

FIG. 2 is a diagram showing an example of a distance computation control process in the distance measuring device according to the first embodiment of the present invention. The distance computation controller 0106 conducts the distance computation control process shown in FIG. 2. Referring to FIG. 2, the distance measuring device according to the first embodiment of the present invention is denoted as 0201, a first person as 0202, and a second person as 0203. The example shown in FIG. 2 assumes that the first person 0202 is a subject who is present in front of a position set up at a distance of Z [m] from the distance measuring device 0201 with a direction of its optical axis as a reference, and that the second person 0203 is a subject who is present at rear of the position set up at the distance of Z [m]. In the present example, the distance computation controller 0106 controls distance computation conditions of the patterned-light-aided distance computing section 0104 and the stereo distance computing section 0105 so that the patterned-light-aided distance computing section 0104 computes a distance to the subject in front of the position set up at the distance of Z [m], and so that the stereo distance computing section 0105 computes a distance to the subject at the rear of the position set up at the distance of Z [m]. The distance of Z [m] that becomes a reference for switching a measuring range. In consideration of the fact that the patterned light attenuates with an increase in the distance from its irradiating section, therefore, it suffices if, for example, an approximate critical distance at which the patterned light can be imaged at a fixed signal level is assigned in the image acquired when the light reflects from the subject of interest, for example the person's skin. At this time, for the human subject 0202 for whom the signal level of the patterned light which reflects is high and for whom the pattern can be detected with sufficiently high accuracy from the image acquired by the first imaging section 0101, highly accurate distance information can be acquired by the execution of the patterned-light-aided distance computation process. For the human subject 0203 for whom, since this person is present at a longer distance from the distance measuring device, the patterned light easily attenuates and becomes difficult to detect from the image, executing the stereo distance computation process in order to avoid likely erroneous matching due to an impact of the patterned light allows highly accurate distance information to be acquired and high distance accuracy to be obtained simultaneously with a measurable-distance range. In the present example, which of the two distance computation processes is to be used is selected using the single determination criterion of Z [m]. At a position immediately close to the distance measuring device 0201, however, there may be a case in which the patterned light that has reflected from the subject cannot be detected from the acquired image because of a focusing failure. Considering this situation, therefore, processing may be controlled to ensure, for example, that the patterned-light-aided distance computing section 0104 conducts a distance computation upon a subject present in a Z1 [m]-Z2 [m] distance range from the distance measuring device 0201, and that the stereo distance computing section 0105 conducts a distance computation upon a subject present in any other distance range. If such control is provided to ensure that the patterned-light-aided distance computing section 0104 and the stereo distance computing section 0105 use the distances from the distance measuring device 0201 and measure the distances to the subjects, high-accuracy and extensive distance measurements can be conducted by adaptively executing patterned-light-aided distance computation for the subject irradiated with the patterned light, and stereo distance computation for the subject not irradiated with the patterned light.

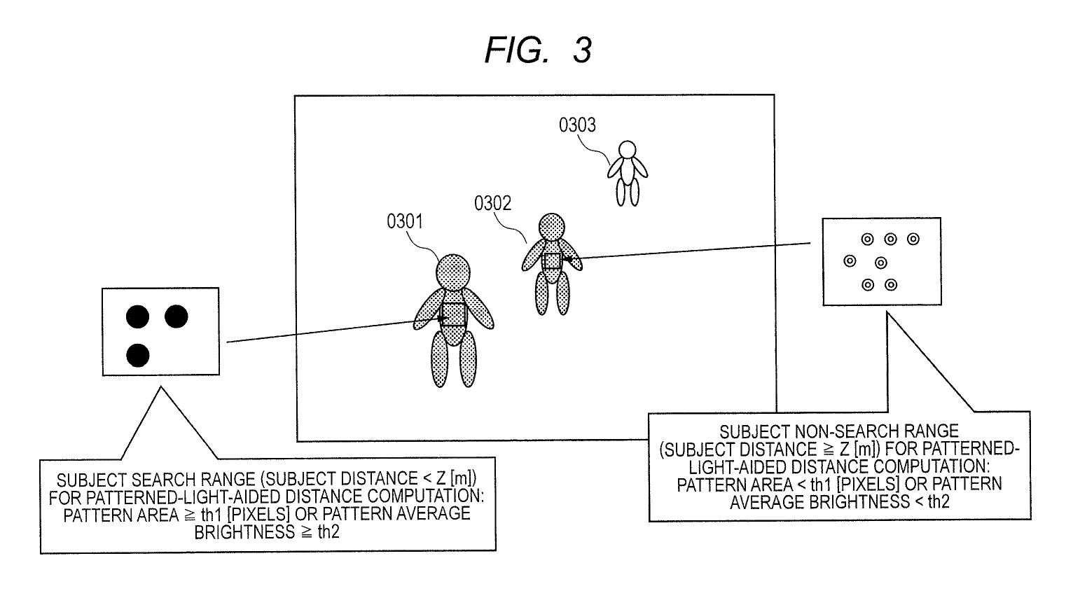

FIG. 3 is a diagram showing an example of a distance computation control process relating to the patterned-light-aided distance computation process in the distance measuring device according to the first embodiment of the present invention. The distance computation controller 0106 conducts the distance computation control process shown in FIG. 3. Referring to FIG. 3, a first person is denoted as 0301, a second person as 0302, and a third person as 0303. The first person 0301 is a subject who is present in front of a position set up at a distance of Z [m] from the distance measuring device 0201 with the direction of its optical axis as a reference. The second person 0302 is a subject who is present at rear of the position set up at the distance of Z [m], and for whom a slight amount of patterned light reflection is reproduced in a formed image. The third person 0303 is a subject who is present at further rear of the position set up at the distance of Z [m], and for whom no amount of patterned light reflection is reproduced in the formed image. In the present example, for the second person 0302, the patterned light is slightly reproduced in the formed image and this light is noise-susceptible, which makes it difficult to measure a distance to the subject accurately with an aid of the patterned light. Accordingly the distance computation controller 0106 sets up threshold values for an area and signal level of the marker which the patterned-light-aided distance computing section 0104 is to detect from the acquired image using Z [m] as the reference, that is, a distance-measuring bound. The patterned-light-aided distance computing section 0104, after detecting the area and signal level of the marker, compares both with the respective threshold values. If one or both of the detected marker area and signal level overstep the threshold values, the patterned-light-aided distance computing section 0104 conducts the distance computation process. The area of the marker is dictated by a diffusion level of the emitted light and the distance to the imaging section, and the signal level of the marker has a correlation with an attenuation ratio depending upon the distance to the imaging section. The patterned-light-aided distance computing section 0104 can therefore conduct the distance computation only upon the subject present within the distance of Z [m], so that processing costs can be reduced. The marker area and signal level threshold values that are appropriate for the distance of Z [m] are desirably predetermined, listed in a correspondence table, and stored into a nonvolatile memory to provide for later use. During actual operation, the signal level of the marker is also affected by composition of the subject and other factors, so using the marker signal level information and the marker area information selectively would be suitable. For example, it would be suitable to use the marker signal level information to obtain distance information relating to a fixed subject, and use only the marker area information to obtain distance information relating to diverse subjects. Another useable alternative would be to take such a measure as to preassign margins to the threshold values so that a marker for a subject more distant from the position of Z [m] in distance can also be detected, and if the distance computed from the detected marker is found to be longer than Z [m], then remove the distance information. Since the distance computation controller 0106 thus controls the thresholding for the detection results of the patterned light, the patterned-light-aided distance computing section 0104 can conduct distance computations within a predetermined measuring range both rapidly and stably.

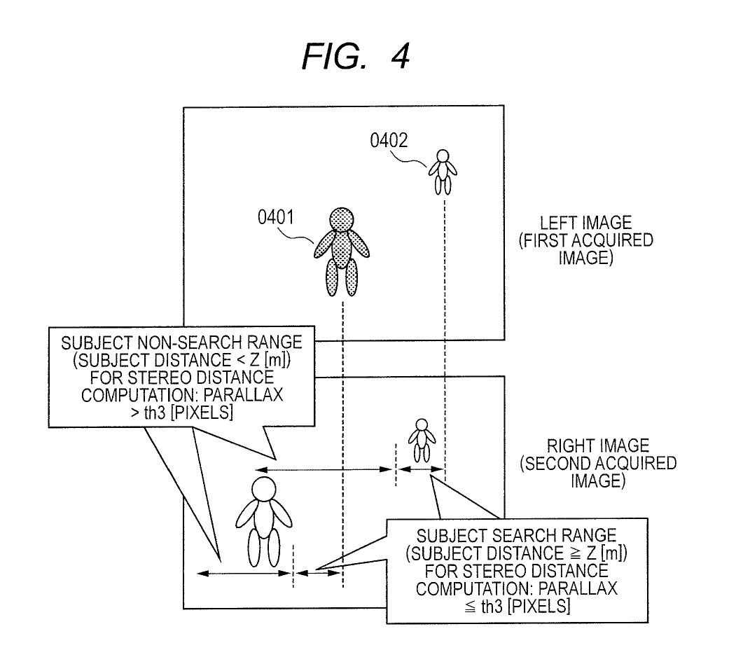

FIG. 4 is a diagram showing an example of a distance computation control process relating to the stereo distance computation process in the distance measuring device according to the first embodiment of the present invention. The distance computation controller 0106 conducts the distance computation control process shown in FIG. 4. Referring to FIG. 4, a first person is denoted as 0401, and a second person as 0402. The first person 0401 is a subject who is present in front of a position set up at a distance of Z [m] from the distance measuring device 0201 with the direction of its optical axis as a reference. The second person 0402 is a subject who is present at rear of the position set up at the distance of Z [m]. In stereo images obtained through calibration such as a lens distortion correction and/or paralleling process, one subject exists on one line in each of the images and a disparity of the subject between the images, that is, parallax varies inversely as the distance to the subject. That is to say, the subject 0401 who is nearer than the position of Z [m] in distance is imaged with parallax greater than a predetermined threshold value of “th3” [pixels], whereas the subject 0402 who is more distant from the position of Z [m] is imaged with parallax equal to or less than the threshold value of “th3” [pixels]. The distance computation controller 0106, therefore, controls the stereo distance computing section 0105 to execute stereo matching between the images and search for one subject only within the threshold data range up to “th3” [pixels]. Thus, the distance computation can only be conducted upon the distance to the subject more distant from the position of Z [m], and hence the amount of computation can be reduced. In a calibrated stereo camera, the threshold value of “th3” can be uniquely determined for the distance of Z [m]. Since the distance computation controller 0106 thus controls the search range during stereo matching, the stereo distance computing section 0105 can conduct distance computations within a predetermined measuring range both rapidly and stably.

FIG. 5 is a diagram showing an example of a distance information integration sequence in the distance measuring device according to the first embodiment of the present invention. The distance information integrator 0107 conducts the distance information integration sequence shown in FIG. 5. In step ST0501 of the distance information integration sequence shown in FIG. 5, the distance information integrator 0107 acquires, from the distance computation controller 0106, the measuring range bound Z [m] of each distance computing section and the determination threshold value “th4” that is the evaluation value indicating the assumed accuracy of the distance information computed by the distance computing sections. The measuring range bound Z and the determination threshold value “th4” may be prestored as adjustment values into the memory or entered from a user interface (not shown) via an interactive type of interface by a user. In step ST0502, the distance information integrator 0107 acquires the computed distance information and the distance evaluation data, from the patterned-light-aided distance computing section 0104 and the stereo distance computing section 0105. In step ST0503, the distance information integrator 0107 makes a selection of pixels corresponding to the two sets of information to be integrated. Since distance information is obtained for each pixel in the acquired image or for each pixel left after image thinning, pixels at which distance information can exist are selected from upper left, in raster order. In step ST0504, whether the results of the distance computation by the patterned-light-aided distance computing section 0104, at the pixels that were selected in step ST0503, are smaller than Z [m] and whether the evaluation value is greater than the threshold value “th4” are determined and if determination results are negative, the sequence proceeds to step ST0506. In step ST0505, the distance information computed by the patterned-light-aided distance computing section 0104 is adopted as distance information corresponding to that pixel position, and the sequence proceeds to step ST0509. In step ST0506, it is determined whether the evaluation value for the distance information computed by the stereo distance computing section 0105, at the pixel position selected in step ST0503, is greater than the threshold value “th4”. If this condition is met, the sequence proceeds to step ST0507. If the condition is not met, the sequence proceeds to step ST0508. In step ST0507, the distance information computed by the stereo distance computing section 0105 is adopted as distance information corresponding to the pixel position, and the sequence proceeds to step ST0509. In step ST0508, information superior as the distance information for the pixels is regarded as having not been obtained in any of the two distance computation processes, with the result that neither of the two sets of computation results is selected and the sequence proceeds to step ST0509. In step ST0509, it is determined whether distance information has been integrated for all pixels. If the integration is not yet completed for a part of the pixels, the sequence is returned to step ST0503 and then repeated for the pixel(s) for which the integration is not completed. Upon completion of the integration for all pixels, the sequence comes to an end. Thus, the distance information that the patterned-light-aided distance computing section 0104 has obtained, and that of the stereo distance computing section 0105 are integrated and distance information highly accurate in the entire image is obtained. The threshold value “th4” for conducting the evaluation-data-based thresholding process for the two sets of distance information acquired by the respective distance computing sections may be applied to both sets of distance information if scales for the respective evaluation values are already normalized. Different threshold values may however be used instead to provide flexibility to adjustments.

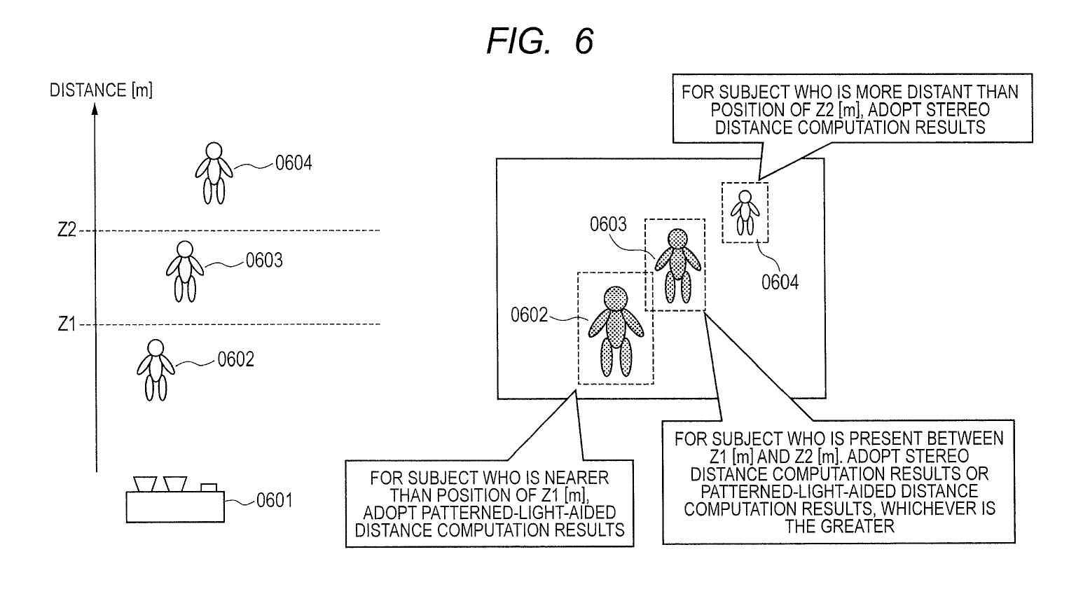

FIG. 6 is a diagram showing an example in which the distance computation control process and distance information integration process in the distance measuring device according to the first embodiment of the present invention are executed by different constituent elements of the device. The distance computation controller 0106 conducts the distance computation control process shown in FIG. 6, and the distance information integrator 0107 conducts the distance information integration process. The example in FIG. 6 is that in which the distance computation controller 0106 controls a distance measuring range of the patterned-light-aided distance computing section 0104 and that of the stereo distance computing section 0105 so that both measuring ranges partly overlap. The present example presupposes that a distance of Z2 [m] from the distance measuring device 0601 is longer than a distance of Z1 [m] from the distance measuring device 0601. Under this presupposition, the patterned-light-aided distance computing section 0104 computes the distances to subjects who are nearer than a position of Z2 [m] in distance, and the stereo distance computing section 0105 computes the distance to subjects who are more distant than the position of Z1 [m]. For the subject in front of the Z1 [m] position, the distance information integrator 0107 adopts pixel-by-pixel distance information acquired by the patterned-light-aided distance computing section 0104. For the subject at rear of the Z2 [m] position, the distance information integrator 0107 adopts pixel-by-pixel distance information acquired by the stereo distance computing section 0105, and for the subject present between the Z1 [m] and Z2 [m] positions, adopts one of the two sets of pixel-by-pixel distance information acquired by both computing sections, whichever is the greater in evaluation value. Thus, even if the subject of interest is present at a position that attenuates the patterned light and makes it difficult for the patterned-light-aided distance computing section 0104 to compute the distance accurately, accuracy of the distance information can be improved by adopting the distance computation results having a greater evaluation value.

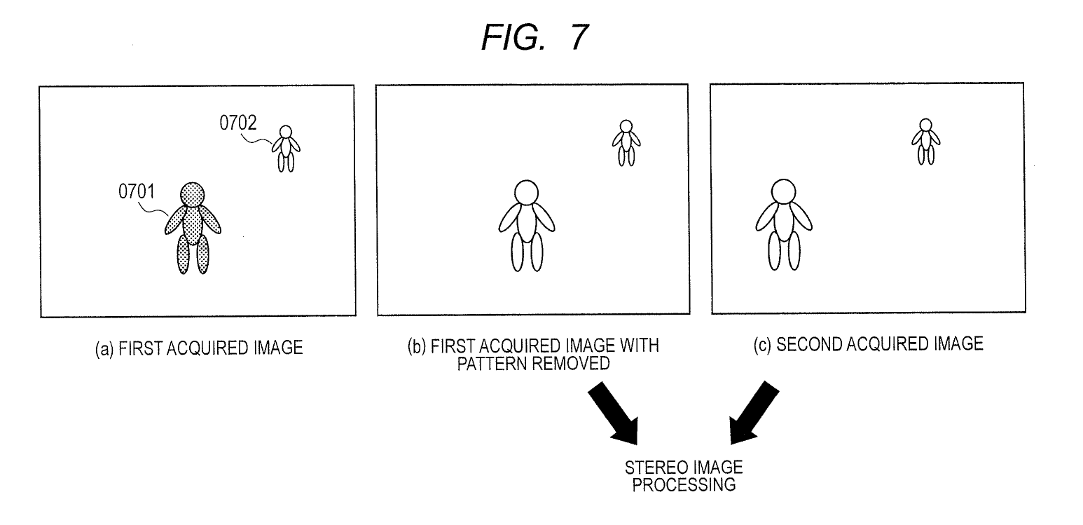

FIG. 7 is a first diagram showing the stereo distance computation process in the distance measuring device according to the first embodiment of the present invention. The stereo distance computing section 0105 conducts the stereo distance computation process shown in FIG. 7. Referring to FIG. 7, an acquired image that the first imaging section 0101 outputs is shown as (a), an image obtained after pattern removal from the acquired image that the first imaging section 0101 outputs is shown as (b), and an acquired image that the second imaging section 0102 outputs is shown as (c). In addition, a first person is denoted as 0701, and a second person as 0702. FIG. 7 assumes that the first person 0701 is a subject who is present between the positions of Z1 [m] and Z2 [m] in the example of FIG. 6, and who is subjected to distance computation in the stereo distance computing section 0105, but irradiated with patterned light. It is also assumed that the second person 0702 is a subject who is present at the rear of the Z2 [m] position and not irradiated with the patterned light. For the first person 0701 at this time, a reflected light pattern is reproduced in the image (a) that the first imaging section 0101 adapted for imaging in an infrared wavelength band has output, but the reflected light pattern is not reproduced in the image (b) that the second imaging section 0102 adapted to cut off light of the infrared wavelength band has output. This causes a stereo matching error in stereo image processing, thus making it difficult to detect correct corresponding points. In this case, the stereo distance computing section 0105, after conducting the patterned-light detection as a preliminary process by feature point detection, template matching, or the like, executes patterned-light elimination based upon smoothing or brightness correction, thereby generating the image (b) from which the patterned light has been removed. Stereo matching with respect to the image (b) output from the second imaging section 0102 is next conducted, which then enables distance information computation even for the subject irradiated with the patterned light.

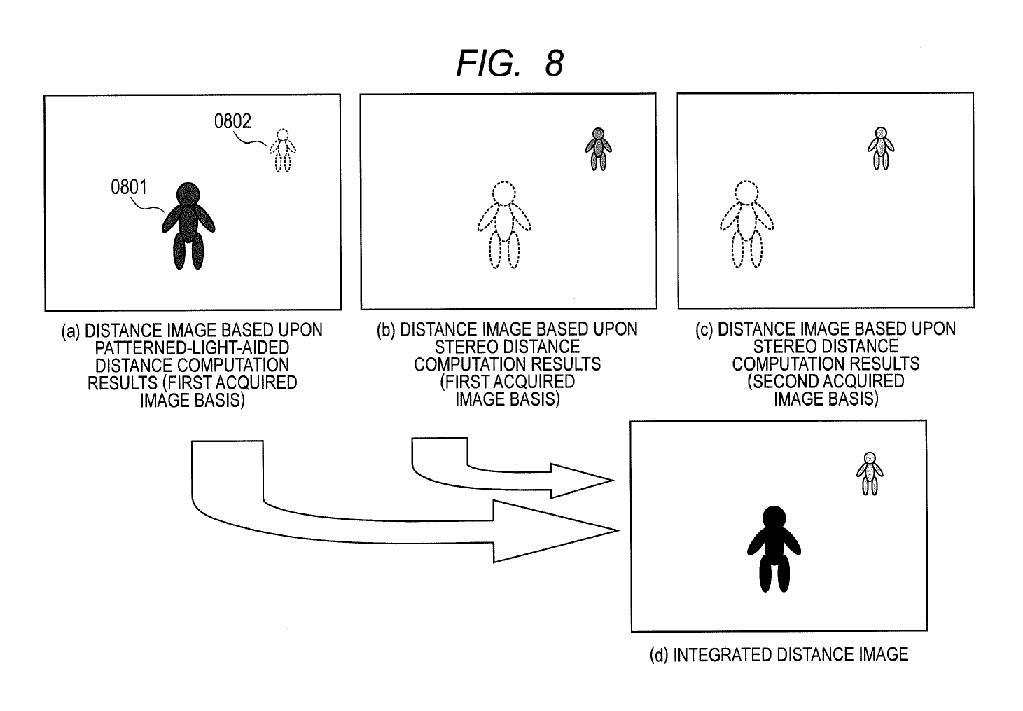

FIG. 8 is a second diagram showing another example of a stereo distance computation process in the distance measuring device according to the first embodiment of the present invention. The stereo distance computing section 0105 conducts the stereo distance computation process shown in FIG. 8. Referring to FIG. 8, a distance image that the patterned-light-aided distance computing section 0104 outputs as an example of distance information, is shown as (a), a distance image derived from a reference image which is a first acquired image that the stereo distance computing section 0105 outputs as an example of distance information, is shown as (b), a distance image derived from a reference image which is a second acquired image that the stereo distance computing section 0105 outputs as an example of distance information, is shown as (c), and a distance image generated by integrating the images (a) and (b) is shown as (d). The distance images here are images generated by visualizing the distance information that the respective distance computing sections have computed, each distance image indicating that a subject of a dark color is present in front and that a subject of a pale color is present at rear. In addition, a subject of a white color is a subject which is not targeted to distance computation and whose distance information is not obtained. The stereo distance computing section 0105 computes distance information on a pixel-by-pixel basis using, as the reference image, one of the images acquired by and output from the first imaging section 0101 and the second imaging section 0102. At this time, the distance information corresponding to each pixel in the image selected as the reference image, can be acquired. The stereo distance computing section 0105, therefore, selects the acquired image that the first imaging section 0101 outputs, as the reference image. Hence, the distance information that the stereo distance computing section 0105 computed can be obtained for the same pixels, so when the distance information integrator 0107 integrates the two sets of distance information, no need arises to execute, for example, coordinate conversion due to the fact that the distance information relating to the same subject is obtained for different pixels. The distance information integration process can therefore be implemented at minimal computing costs.

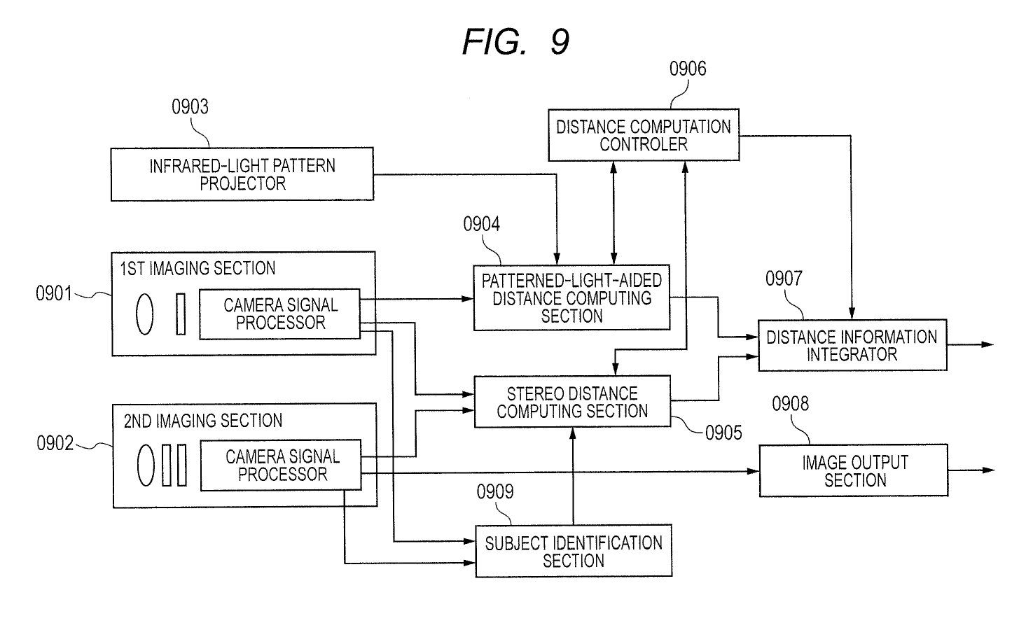

FIG. 9 is a second schematic diagram showing another example of a distance measuring device according to the first embodiment of the present invention. Referring to FIG. 9, the distance measuring device includes a first imaging section 0901, a second imaging section 0902, a patterned-infrared-light projector 0903, a patterned-light-aided distance computing section 0904, a stereo distance computing section 0905, a distance computation controller 0906, a distance information integrator 0907, an image output section 0908, and a subject identification section 0909. That is to say, the device configuration shown in FIG. 9 includes the subject identification section 0909, plus the device configuration in the first schematic diagram of FIG. 1 showing the distance measuring device according to the first embodiment of the present invention.

In the distance measuring device of FIG. 9, the subject identification section 0909 conducts image processing upon an acquired image that the first imaging section 0901 outputs, and an acquired image that the second imaging section 0902 outputs, and then the subject identification section 0909 identifies specific subjects from brightness information, color information, brightness distribution information, and the like. In accordance with subject identification information that the subject identification section 0909 outputs, the stereo distance computing section 0905 conducts inter-image sensitivity corrections with subject-dependent coefficients, as stereo image preprocessing. Since the reflectance and absorptivity of light in infrared wavelength bands vary from composition to composition of a subject, imaging sensitivity of the first imaging section 0901 capable of imaging light of an infrared wavelength band, and that of the second imaging section 0902 which cuts off the light of the infrared wavelength band differ for each type of subject. Accordingly, conducting sensitivity corrections using the coefficients that differ for each type of subject allows the difference in sensitivity between images to be appropriately corrected, which in turn improves computing accuracy of the distance computation process based upon stereo image processing. To conduct a matching process based upon stereo image processing, a matching technique such as increment sign correlation with an increment sign for brightness, not with the brightness itself, may be useable; the matching process will further improve robustness against the sensitivity difference in the infrared wavelength bands.

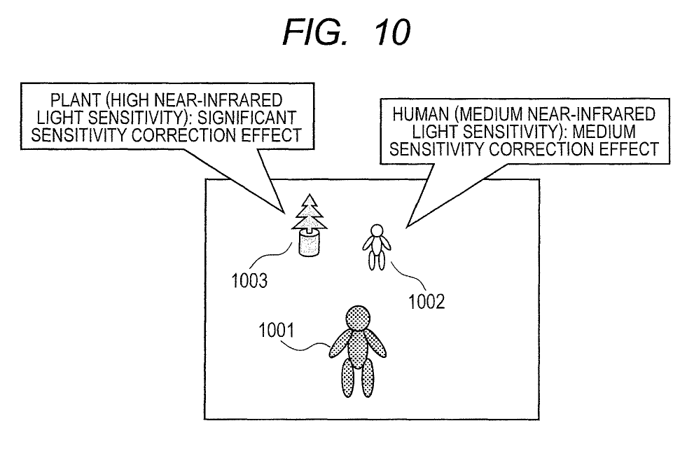

FIG. 10 is a diagram showing a sensitivity correction process in the distance measuring device according to the first embodiment of the present invention. The stereo distance computing section 0905 conducts the sensitivity correction process shown in FIG. 10. Referring to FIG. 10, a first person is denoted as 1001, a second person as 1002, and a plant as 1003. Since the plant reflects more of the light of an infrared wavelength band than the persons, the stereo distance computing section 0905 can correct the difference in sensitivity between images appropriately for each subject by conducting, for the plant, the sensitivity correction with a larger coefficient than for the persons, based upon the subject identification information that the subject identification section 0909 outputs. The subject identification section 0909 needs only to be able to determine and identify a target subject estimated or likely to be a plant, from, for example a color image that the second imaging section 0102 outputs, green and/or other color information, a distribution of microscopic or subtle changes in brightness, or other data or information. Other known methods of identifying subjects may also be used. Executing the appropriate sensitivity correction for each subject in this manner allows stereo image processing to be conducted uniformly and thus distance computations to be conducted with high accuracy.

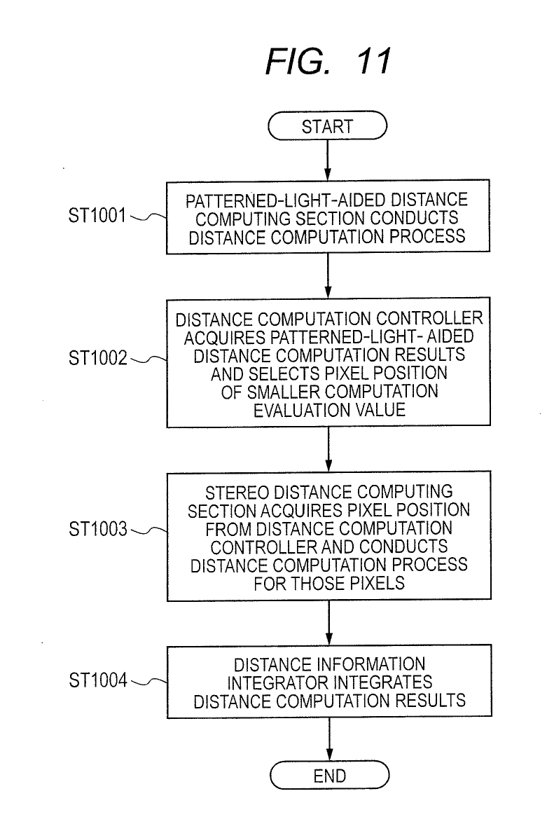

FIG. 11 is a diagram showing an example of a distance computation control sequence in the distance measuring device according to the first embodiment of the present invention. In the example of distance computation control that is shown in FIG. 2, the patterned-light-aided distance computing section 0104 and the stereo distance computing section 0105 have been controlled to compute distances independently within the distance measuring ranges based upon the distance information from the distance measuring device. In the example of the distance computation control sequence that is shown in FIG. 11, however, the patterned-light-aided distance computing section 0104 and the stereo distance computing section 0105 compute distances independently for each subject without relying upon the distance information from the distance measuring device.

In step ST1001 of the distance computation control sequence shown in FIG. 11, the patterned-light-aided distance computing section 0104 conducts a distance computation process and outputs distance information. In step ST1002, the distance computation controller 0106 acquires computation results from the patterned-light-aided distance computing section 0104, then selects a pixel position determined to have a low evaluation value for the computation results and contain inaccurate distance information, and outputs the pixel information. In step ST1003, the stereo distance computing section 0105 acquires from the distance computation controller 0106 the pixel position at which the patterned-light-aided distance computing section 0104 has failed to compute distance information, and conducts stereo image processing to conduct the distance computation process for the particular pixels. In step ST1004, the distance information integrator 0107 integrates the distance computation results and substitutes the distance information corresponding to the pixel position at which the patterned-light-aided distance computing section 0104 failed to compute distance information, by the distance information computed by the stereo distance computing section 0105. The substitution allows the stereo distance computing section 0105 to compute accurate distance information, even for a subject for whom or which, in spite of this subject being present near the distance measuring device, the patterned-light-aided distance computing section 0104 cannot conduct distance measurement by reason of, for example, the subject being unable to absorb the light of an infrared wavelength band and enable pattern detection in the acquired image. For a distant subject that attenuates the patterned light, accurate distance information can be computed with the stereo distance computing section 0105. The stereo distance computing section 0105 needs only to execute distance computation only for the pixels where the patterned-light-aided distance computing section 0104 failed to obtain distance information. The amount of calculation, therefore, can also be reduced. This leads to preventing a lack of distance information, since distance measurement by stereo distance computing can be executed even for such a subject that does not enable low-cost distance measurement based upon patterned-light-aided distance computations.

In this way, in accordance with the present embodiment, the distance measurement that is highly accurate and wide in measuring range can be executed in a limited device configuration, and this characteristic allows the distance measuring device to be reduced in costs and improved in performance.

### Second Embodiment

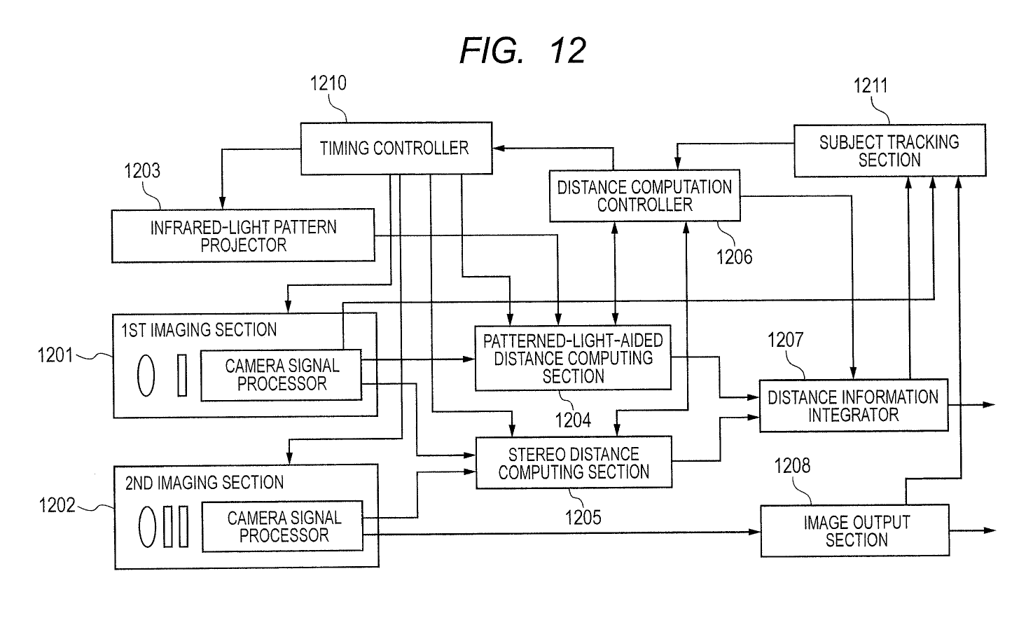

FIG. 12 is a schematic diagram of a distance measuring device according to a second embodiment of the present invention. Referring to FIG. 12, the distance measuring device includes a first imaging section 1201, a second imaging section 1202, a patterned-infrared-light projector 1203, a patterned-light-aided distance computing section 1204, a stereo distance computing section 1205, a distance computation controller 1206, a distance information integrator 1207, an image output section 1208, a timing controller 1210, and a subject tracker 1211. That is to say, the device configuration in the second embodiment includes the timing controller 1210 and the subject tracker 1211, plus the device configuration in the first schematic diagram of FIG. 1 showing the distance measuring device according to the first embodiment of the present invention.

In the distance measuring device of FIG. 12, on the basis of control timing information which the distance computation controller 1206 outputs, the timing controller 1210 controls a patterned-infrared-light projection period of the infrared-light projector 1203, image acquisition timing and acquired-image output timing of the first imaging section 1201 and second imaging section 1202, and distance computation timing of the patterned-light-aided distance computing section 1204 and stereo distance computing section 1205. Thus, the patterned-light-aided distance computing section 1204 is controlled to conduct a distance computation upon the acquired image that the first imaging section 1201 outputs when the patterned infrared light is being projected, and the stereo distance computing section 1205 is controlled to conduct distance computations upon the acquired images that the first imaging section 1201 and second imaging section 1202 output when the patterned infrared light is not being projected. The distance computation by the patterned-light-aided distance computing section 1204 and the distance computations by the stereo distance computing section 1205 take place in synchronization. In the stereo distance computing section 1205, therefore, stereo image processing can be executed using the images not affected by the patterned light, with the result that distance computation accuracy improves. The subject tracker 1211 executes background subtraction/differencing, labeling, filtering, etc., on a frame-by-frame basis, by using any one independently, or at least two in combination, of the acquired image output from the first imaging section 1201, an image output from the image output section 1208, and distance information output from the distance information integrator 1207. In this manner, the subject tracker 1211 detects a specific subject such as a moving person, and tracks the detected subject using information indicative of its time-varying changes in position. The distance computation controller 1206 acquires subject tracking results from the subject tracker 1211, and after determining which of the two distance computing sections, namely the patterned-light-aided distance computing section 1204 and the stereo distance computing section 1205, is to be used in next frame to compute a distance to the subject tracked, and outputs control timing information to the timing controller 1210 so as to make the selected distance computing section effective. Thus, if a distance detector is diverted for intruder detection in order to compute distance information concerning a specific subject more accurately for such purposes as tracking an intruder, the acquisition of highly accurate distance information and the tracking of the subject can be implemented by switching the patterned-light-aided distance computing section 1204 and the stereo distance computing section 1205 adaptively.

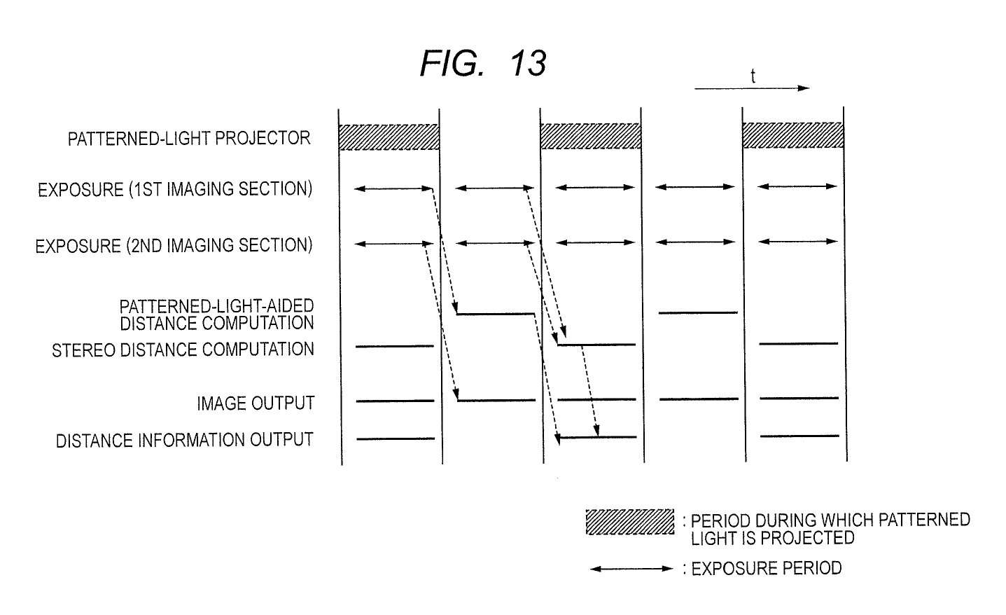

FIG. 13 is a diagram showing an example of a timing control process in the distance measuring device according to the second embodiment of the present invention. The timing controller 1210 conducts the timing control process shown in FIG. 13. Referring to FIG. 13, a horizontal axis denotes an elapse of time and a vertical axis denotes the types of ongoing processes for each frame. The present example assumes that the patterned-light-aided distance computing section 1204 and the stereo distance computing section 1205 are controlled so that distance computation execution means intermittently alternates between both every other frame. The patterned-infrared-light irradiating section 1203 turns patterned-infrared-light irradiation on and off for each frame, the patterned-light-aided distance computing section 1204 computes distance timely with respect to timing in which the first imaging section 1201 acquires and outputs an image by conducting exposure while the patterned light is being emitted, the stereo distance computing section 1205 computes distances timely with respect to timing in which the first imaging section 1201 and the second imaging section 1202 acquire and output images by conducting exposure while the patterned light is not being emitted, and the distance information integrator 1207 integrates distance information timely with respect to timing in which distance computation results by the patterned-light-aided distance computing section 1204 and those of the stereo distance computing section 1205 are both obtained. The image output section 1208 outputs the acquired image that has been output from the second imaging section 1202 for each frame, as an image to be displayed. In this way, the distance measuring device can output acquired images in a full-frame format. The device can also output highly accurate distance information at half-frame intervals. In the above example, distance computation alternates between the patterned-light-aided distance computing section 1204 and the stereo distance computing section 1205. After focusing, however, for example in consideration of a fact that a more distant subject is of less importance, distance information relating to a nearer subject may be updated more frequently by making an execution rate of the distance computation process in the stereo distance computing section 1205 lower than that of the distance computation process in the patterned-light-aided distance computing section 120.

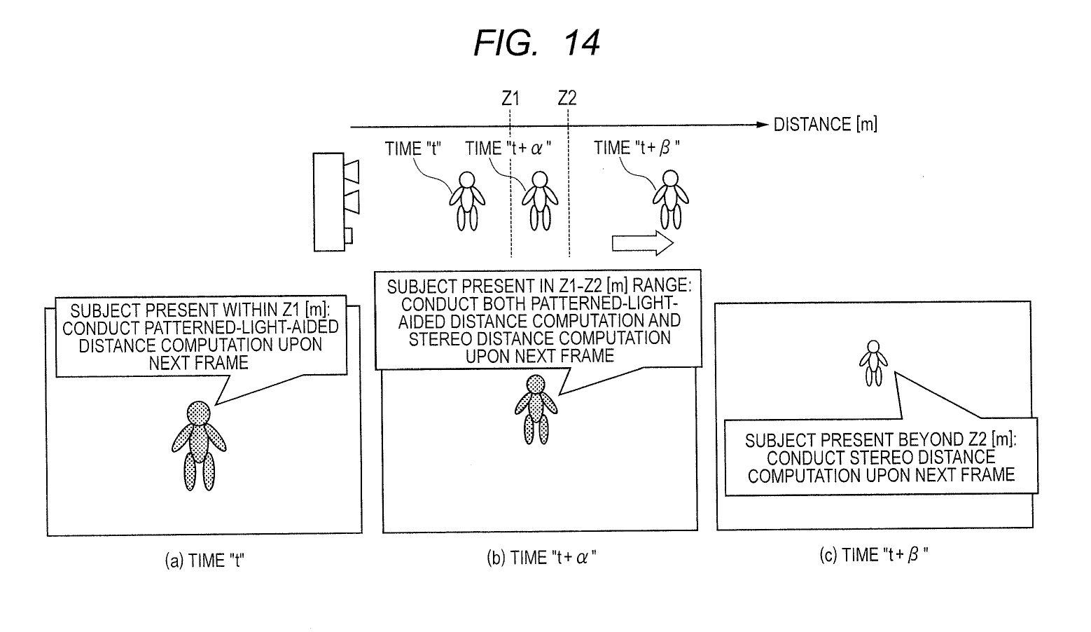

FIG. 14 is a diagram showing an example of a distance computation control process in the distance measuring device according to the second embodiment of the present invention. The distance computation controller 1206 conducts the distance computation control process shown in FIG. 14. In FIG. 14 showing the distance computation control process, an image acquired by the first imaging section 1201 at time “t” is denoted as (a), an image an image acquired by the first imaging section 1201 at time “t+á” is denoted as (b), and an image acquired by the first imaging section 1201 at time “t+â” is denoted as (c). This distance computation process assumes that as time of the day changes from “t” through “t+á.” to “t+â”, a person moves further away from the distance measuring device. During this duration, the subject tracker 1211 detects and tracks the person as an intruder, and the distance computation controller 1206 acquires tracking results that the subject tracker 1211 outputs for the person. At the time “t”, since the person is present at a short distance of Z1 [m] from the distance measuring device, the control timing of the timing controller 1210 is determined so that the patterned-light-aided distance computing section 1204 conducts distance in next frame, and at the time “t+â”, since the person is present at a long distance of Z2 [m] from the distance measuring device, the control timing of the timing controller 1210 is determined so that the stereo distance computing section 1205 conducts distance in the next frame. This control allows both distance computing sections to acquire highly accurate distance information. Additionally, at the time “t+á” that the person is present between the distances of Z1 [m] and Z2 [m], the control timing is determined so that the patterned-light-aided distance computing section 1204 and the stereo distance computing section 1205 both conduct distances at the same time. This prevents an omission of distance measurement, thus allowing appropriate distance measurement according to a particular position of the subject of interest, and hence, highly accurate distance information acquisition and subject tracking.

As described above, in accordance with the present embodiment, highly accurate distance computing free from any impacts of the patterned light can be executed during stereo distance computation by switching the patterned-light-aided distance computation and the stereo distance computation on a time basis.

### Third Embodiment

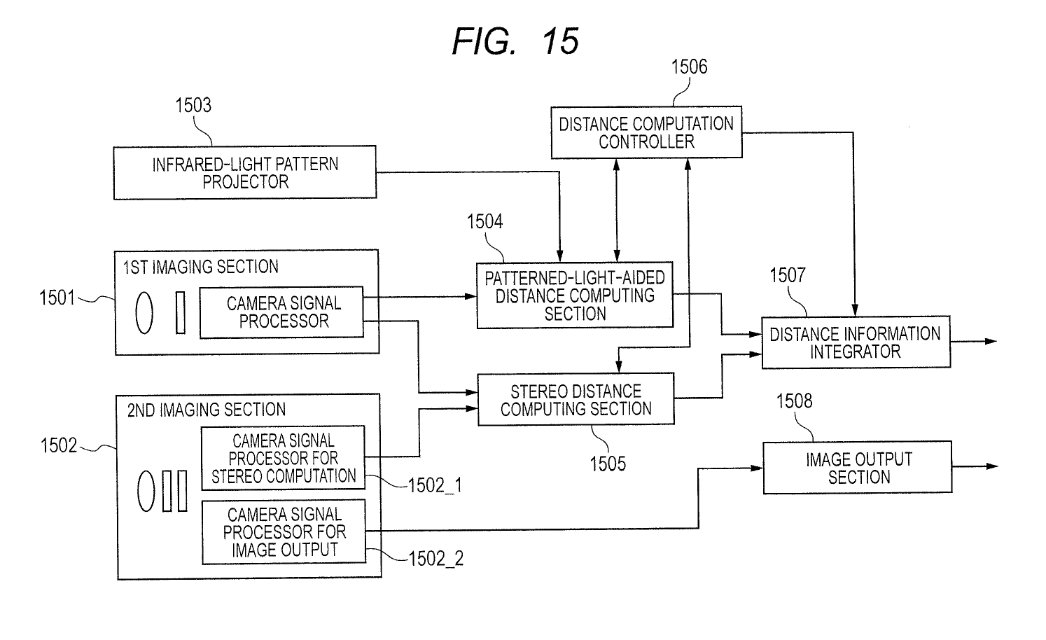

FIG. 15 is a schematic diagram of a distance measuring device according to a third embodiment of the present invention. Referring to FIG. 15, the distance measuring device includes a first imaging section 1501, a second imaging section 1502, a camera signal processor 1502_1 for stereo computation, a camera signal processor 1502_2 for image output, a patterned-infrared-light projector 1503, a patterned-light-aided distance computing section 1504, a stereo distance computing section 1505, a distance computation controller 1506, a distance information integrator 1507, and an image output section 1508. The device configuration of the third embodiment includes the plurality of camera signal processors in the second imaging section 1502, with all other constituent elements being the same as in the first schematic diagram of FIG. 1 showing the distance measuring device according to the first embodiment of the present invention.

The imaging section 1502 of the distance measuring device shown in FIG. 15 includes a lens group with a zoom lens and a focusing lens. The imaging section 1502 also includes an iris, a shutter, an infrared-light cutoff filter, an image pickup element such as a CCD or CMOS circuit, a CDS or AGC circuit, an A-D converter, etc. The imaging section 1502, after its image pickup element has detected incoming light and formed an optical image, converts the image into an electrical signal, and then the stereo computing camera signal processor 1502_1 conducts camera signal processing other than nonlinear-signal processing such as brightness generation, noise reduction, and edge enhancement, and outputs a resulting signal to the stereo distance computing section 1505. In addition, the image output camera signal processor 1502_2 conducts camera signal processing such as brightness generation, color generation, noise reduction, edge enhancement, and nonlinear gamma processing, and outputs a resulting signal as a color image signal to the image output section 1508. In this way, the second imaging section 1502 executes the plurality of types of signal processing according to requirements, the result being that in the stereo distance computing section 1505, an image suitable for stereo image processing, and in the patterned-light-aided distance computing section 1504, an image suitable for image recognition in color image mode or for image display on a monitor can be used at high S/N ratios independently.

As set forth above, in accordance with the present embodiment, the accuracy of stereo distance computations and the S/N ratio of the image displayed can be improved.

### Fourth Embodiment

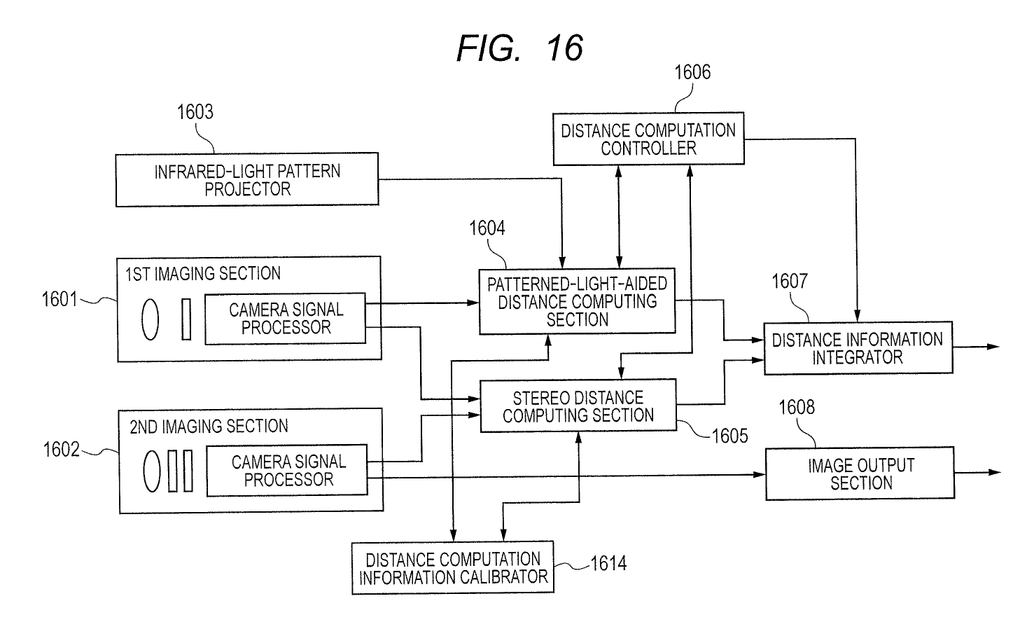

FIG. 16 is a schematic diagram of a distance measuring device according to a fourth embodiment of the present invention. Referring to FIG. 16, the distance measuring device includes a first imaging section 1601, a second imaging section 1602, a patterned-infrared-light projector 1603, a patterned-light-aided distance computing section 1604, a stereo distance computing section 1605, a distance computation controller 1606, a distance information integrator 1607, an image output section 1608, and a distance computation information calibrator 1614. The device configuration of the present embodiment includes the distance computation information calibrator 1614 plus the device configuration in the first schematic diagram of FIG. 1 showing the distance measuring device according to the first embodiment of the present invention.

The distance computation information calibrator 1614 of the distance measuring device shown in FIG. 16 acquires distance information from both of the patterned-light-aided distance computing section 1604 and the stereo distance computing section 1605, and then by comparing the two sets of distance information relating to one subject, computes and updates calibration information required for either the patterned-light-aided distance computing section 1604 or the stereo distance computing section 1605 to calculate an absolute distance. Thus, even in a case that although relative distance information with respect to periphery cannot be computed in either the patterned-light-aided distance computing section 1604 or the stereo distance computing section 1605, focal length and/or other scaling factors are unknown and the absolute distance is not accurately measurable, a calibration can be conducted to make the absolute distance computable by using another set of absolute distance information as teaching information.

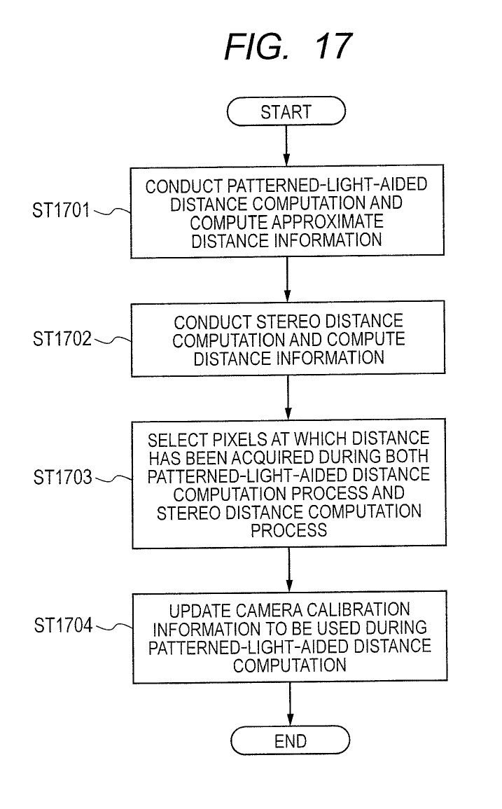

FIG. 17 is a diagram showing an example of a distance computation information calibration sequence in the distance measuring device according to the fourth embodiment of the present invention. The present example envisages the following case: when stereo distance computation is to take place using the first imaging section 1601 and the second imaging section 1602, calibration is already completed and an absolute distance to a subject can be acquired, whereas, when patterned-light-aided distance computation is to take place using both an image acquired by the first imaging section 1601 and the patterned light projected by the patterned-infrared-light projector 1603, relative distance information cannot be acquired by reason of, for example, a focal length or other scaling factors of the patterned-infrared-light projector 1603 not being strictly calibrated.

In step ST1701 of FIG. 17, the patterned-light-aided distance computing section 1604 conducts the patterned-light-aided distance computation process and computes an approximate, relative distance to the subject. In step ST1702, the stereo distance computing section 1605 conducts the stereo distance computation process and computes a highly accurate, absolute distance to the subject. In step ST1703, the distance computation information calibrator 1614 makes a selection of pixels at which the patterned-light-aided distance computing section 1604 and the stereo distance computing section 1605 have each acquired different distance information whose evaluation value is greater than a threshold value. In step ST1704, on the basis of the absolute distance information that the stereo distance computing section 1605 outputs for the pixels that were selected in step ST1703, the distance computation information calibrator 1614 calculates the focal length and other information required for the patterned-light-aided distance computing section 1604 to compute absolute distance information, and stores the calculated information as calibration information into a memory or the like. Thus, subsequent use of this calibration information allows the calculation of the absolute distance in the patterned-light-aided distance computing section 1604 as well. In addition, the distance computation information calibration sequence in the distance measuring device, shown in FIG. 17, may be periodically executed to suppress decreases in computation accuracy of the absolute distance over time.

As described above, in accordance with the present embodiment, comparison between patterned-light-aided distance computation results and stereo distance computation results enables one of the two sets of distance computation results to be calibrated from the other set of distance computation results.

### Fifth Embodiment

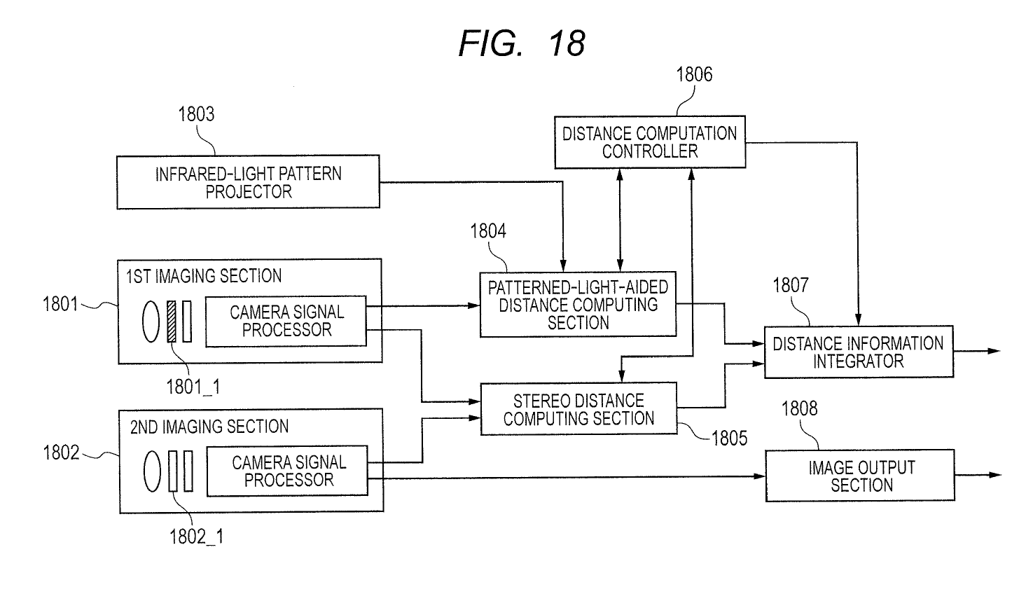

FIG. 18 is a schematic diagram of a distance measuring device according to a fifth embodiment of the present invention. Referring to FIG. 18, the distance measuring device includes a visible-light cutoff filter 1801_1, a first imaging section 1801 with the visible-light cutoff filter, an infrared-light cutoff filter 1802_1, a second imaging section 1802 with the infrared-light cutoff filter, a patterned-infrared-light projector 1803, a patterned-light-aided distance computing section 1804, a stereo distance computing section 1805, a distance computation controller 1806, a distance information integrator 1807, and an image output section 1808. In the device configuration of the present embodiment, the first imaging section 1801 with the visible-light cutoff filter replaces the first imaging section 0101 in the first schematic diagram of FIG. 1 showing the distance measuring device according to the first embodiment of the present invention. A characteristic difference between the first imaging section 0101 and the first imaging section 1801 with the visible-light cutoff filter is whether the visible-light cutoff filter is present. In the imaging section 0101, the image pickup element having spectral response characteristics in wavelength bands of near-infrared light in addition to visible light can image a target subject which includes near-infrared components. The imaging section 1801 with the visible-light cutoff filter, on the other hand, includes an image pickup element that while it does not have spectral response characteristics in the wavelength band of visible light, the image pickup element can acquire an image of a target subject free of visible light components. For this reason, when the patterned-light-aided distance computing section 1804 executes image processing and detects, from the image that the first imaging section 1801 with the visible-light cutoff filter acquires when the patterned-infrared-light projector 1803 projects patterned infrared light, a pattern reproduced on the subject after reflection of the light, the patterned-light-aided distance computing section 1804 compares that image with another acquired image containing visible light components. By making this comparison, the patterned-light-aided distance computing section 1804 can easily discriminate the subject irradiated with the patterned infrared light, from other subjects. This characteristic yields advantages in that improvement of detection performance leads to that of distance measuring accuracy, in that impacts of a disturbance are reduced, and in that calculation costs associated with detection are also reduced.

The stereo distance computing section 1805 conducts stereo image processing based upon both of the acquired image containing infrared components that is output from the first imaging section 1801 including the visible-light cutoff filter, and the acquired image containing visible light components that is output from the second imaging section 1802 including the infrared-light cutoff filter. After that, the stereo distance computing section 1805 computes and outputs distance information and reliability of this information. At this time, since spectral sensitivity significantly differs between stereo images, stereo matching with brightness information may be replaced by, for example, detecting edge components and other feature quantities and conducting stereo matching between the feature quantities in each image, such that stable distance measurement results will be obtained even if the difference in sensitivity exists. Detection accuracy can be further improved if an identification element for the feature quantity detection allowing for reflection characteristics of infrared components is used for the acquired image containing infrared components that is output from the first imaging section 1801 including the visible-light cutoff filter, and an identification element for the feature quantity detection allowing for reflection characteristics of visible light components is used for the acquired image containing visible light components that is output from the second imaging section 1802 including the infrared-light cutoff filter.

In addition, the distance measuring device according to the fifth embodiment of the present invention is configured so that under an outdoor environment, the first imaging section 1801 with the visible-light cutoff filter can image infrared components of a subject using the light of an infrared wavelength band that is included in natural light. The device may however be configured so that at night or indoors, the infrared components of the subject can be imaged using the distance measuring device in conjunction with a light source such as an infrared LED.

As described above, while improving distance measuring performance based upon the projection of the patterned infrared light, the present embodiment enables distance measurement in a wide range, and hence, reduction in costs of the distance measuring device and improvement of its performance.

### Sixth Embodiment

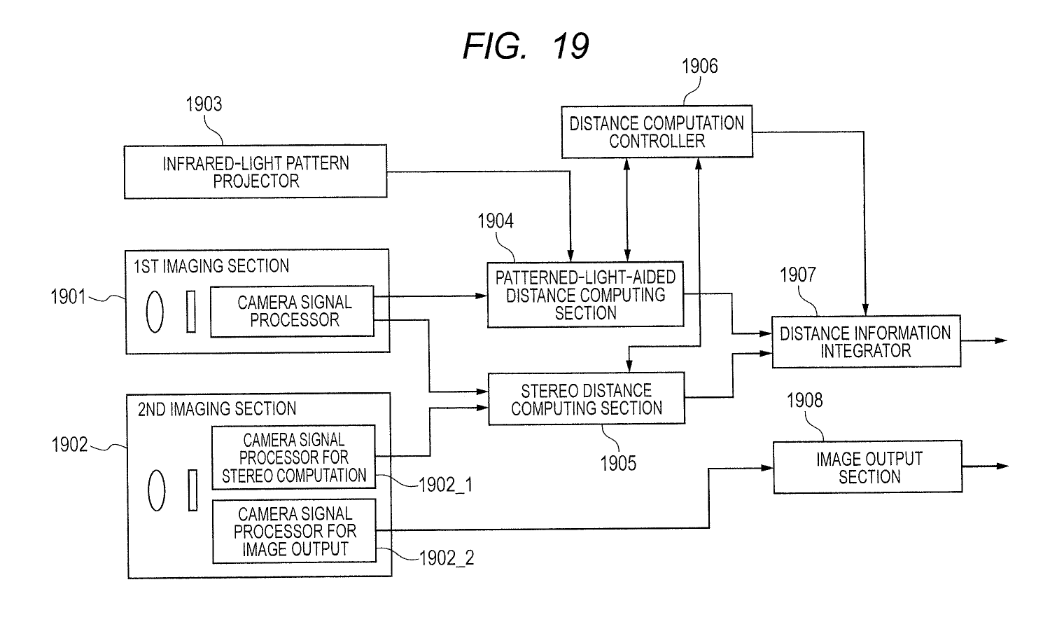

FIG. 19 is a schematic diagram of a distance measuring device according to a sixth embodiment of the present invention. Referring to FIG. 19, the distance measuring device includes a first imaging section 1901, a second imaging section 1902, a camera signal processor 1902_1 for stereo computation, a camera signal processor 1902_2 for image output, a patterned-infrared-light projector 1903, a patterned-light-aided distance computing section 1904, a stereo distance computing section 1905, a distance computation controller 1906, a distance information integrator 1907, and an image output section 1908. A characteristic difference between the distance measuring device according to the third embodiment of the present invention and the distance measuring device according to the sixth embodiment of the invention is whether the second imaging section includes an infrared-light cutoff filter is present. The imaging section 1502 includes an infrared-light cutoff filter, and the image pickup element of the imaging section 1502 has spectral response characteristics in a wavelength band of visible light and can image a target subject that includes visible light components. The imaging section 1902, on the other hand, does not include an infrared-light cutoff filter, and the image pickup element of the imaging section 1902 has spectral response characteristics in wavelength bands of near-infrared light in addition to visible light and can acquire an image of a target subject that includes near-infrared light components. For this reason, the first imaging section 1901 and the second imaging section 1902 have substantially the same spectral sensitivity and the stereo distance computing section 1905 can conduct highly accurate matching between stereo images. These characteristics yield advantages in that improvement of detection performance leads to that of distance measuring accuracy, in that impacts of a disturbance are reduced, and in that calculation costs associated with detection are also reduced.

The image output camera signal processor 1902_2 conducts camera signal processing such as brightness generation, color generation, noise reduction, edge enhancement, and nonlinear gamma processing, and outputs a resulting signal as a color image signal to the image output section 1908. At this time, since the image acquired by and output from the second imaging section 1902 shown in FIG. 19 includes infrared components, execution of the color generation process is likely to reduce color reproducibility, compared with execution of the color generation process for the image acquired by and output from the second imaging section 1502 shown in FIG. 15. The image output camera signal processor 1902_2 may therefore be configured to output only a brightness signal as an image signal, instead of the color image signal, to the image output section 1908. This output enables suppression of a decrease in visibility due to a decrease in color reproducibility.

As described above, while improving distance measuring performance based upon stereo image processing, the present embodiment enables distance measurement in a wide range, and hence, reduction in costs of the distance measuring device and improvement of its performance.

The present invention is not limited to the above-described embodiments and can encompass various modifications. For example, the embodiments have only been detailed for a more understandable description of the invention and are not necessarily limited to configurations including all the constituent elements described above. In addition, part of the configuration in one embodiment can be replaced with the configuration of another embodiment, or the configuration of a certain embodiment can be added to that of another embodiment. Furthermore, part of the configuration in each embodiment can be added, deleted, or replaced, as appropriate in the other embodiments. The present invention can be applied to various types of cameras provided with a distance measuring function, such as a consumer type, monitoring type, vehicular type, cell phone type, measuring type, and business type.

What is claimed is:

1. A distance measuring device comprising:
first imaging means having spectral response characteristics in a wavelength band of visible light and in a predetermined wavelength band of invisible light;
second imaging means having spectral response characteristics in the wavelength band of the visible light, the second imaging means having no spectral response characteristics in the predetermined wavelength band of the invisible light;
invisible-light projection means adapted to project the invisible light of the predetermined wavelength band in an angle-of-view range of the first imaging means;
invisible-light-aided distance computation means adapted to conduct image processing of an image formed by and output from the first imaging means, then compute a first distance to a target subject on a basis of information contained in the invisible light of the predetermined wavelength band that is projected onto the subject detected from the image, and output the first distance information;
stereo distance computation means adapted to conduct stereo image processing of both the image formed by and output from the first imaging means and an image formed by and output from the second imaging means, then compute a second distance to the subject, and output the second distance information; and
distance computation control means adapted to control computation conditions used for the invisible-light-aided distance computation means and the stereo distance computation means to conduct the respective computations.

2. The distance measuring device according to claim 1, wherein
the invisible light of the predetermined wavelength band projected from the invisible-light projection means is light of a near-infrared wavelength band, and has a predetermined pattern.

3. The distance measuring device according to claim 1, wherein
the computation conditions that the distance computation control means uses include a distance measuring range of the invisible-light-aided distance computation means, as a predetermined first distance-measuring range, and a distance measuring range of the stereo distance computation means, as a predetermined second distance-measuring range.

4. The distance measuring device according to claim 3, wherein
the distance computation control means sets the predetermined first distance-measuring range and the predetermined second distance-measuring range so that the two measuring ranges do not overlap.

5. The distance measuring device according to claim 3, wherein the distance computation control means sets the predetermined first distance-measuring range and the predetermined second distance-measuring range so that the two measuring ranges partly overlap.

6. The distance measuring device according to claim 3, wherein
in the acquired image that the first imaging means outputs, the invisible-light-aided distance computation means computes only the distance to the subject present in the predetermined first distance-measuring range, on a basis of both of a pattern size on the acquired image of the invisible light and a signal level.

7. The distance measuring device according to claim 3, wherein
the stereo distance computation means computes only the distance to the subject present in the predetermined second distance-measuring range, on a basis of a parallax range of the same subject in the images acquired by and output from the first imaging means and the second imaging means.

8. The distance measuring device according to claim 1, further comprising:
distance information integration means adapted to acquire the distance computation conditions controlled by the distance computation control means, integrate the distance information output from the invisible-light-aided distance computation means and the distance information output from the stereo distance computation means, and output the two sets of distance information as one set of distance information.

9. The distance measuring device according to claim 8, wherein
when the stereo distance computation means conducts a distance computation based upon stereo image processing, the acquired image that the first imaging means outputs serves as a reference image for stereo image processing.

10. A distance measuring device comprising:
first imaging means having spectral response characteristics in a wavelength band of visible light and in a predetermined wavelength band of invisible light;
second imaging means having spectral response characteristics in the wavelength band of the visible light, the second imaging means having no spectral response characteristics in the predetermined wavelength band of the invisible light; and
stereo distance computation means adapted to conduct stereo image processing of both an image which includes components of the predetermined wavelength band of the invisible light, the image being formed by and output from the first imaging means, and an image which does not include components of the predetermined wavelength band of the invisible light, the image being formed by and output from the second imaging means, then compute a distance to a target subject, and output the distance information.

11. The distance measuring device according to claim 1, wherein
the stereo distance computation means, after correcting differential sensitivity based upon a difference in useable imaging wavelength band, conducts stereo image processing upon both of the image acquired by and output from the first imaging means, and the image acquired by and output from the second imaging means, computes the distance to the subject, and outputs the distance information.

12. The distance measuring device according to claim 1, further comprising:
subject identification means adapted to identify a specific subject by conducting image processing upon either the acquired image that the first imaging means outputs, or the acquired image that the second imaging means outputs;
wherein the stereo distance computation means, after correcting differential sensitivity based upon a difference in useable imaging wavelength band by using different weights for the specific subject identified by the subject identification means, conducts stereo image processing upon both of the image acquired by and output from the first imaging means, and the image acquired by and output from the second imaging means, computes the distance to the subject, and outputs the distance information.

13. The distance measuring device according to claim 1, wherein
the distance computation control means controls the distance computation conditions so that the invisible-light-aided distance computation means computes distance information relating to subjects being represented in all or part of an internal region of an image, and that upon the invisible-light-aided distance computation means failing to compute distance information for a subject, the stereo distance computation means computes only distance information relating to the particular subject.

14. A distance measuring device comprising:
first imaging means having spectral response characteristics in a wavelength band of visible light and in a predetermined wavelength band of invisible light;
second imaging means having spectral response characteristics in the wavelength band of the visible light, the second imaging means having no spectral response characteristics in the predetermined wavelength band of the invisible light;
invisible-light projection means adapted to project the invisible light of the predetermined wavelength band in an angle-of-view range of the first imaging means;
invisible-light-aided distance computation means adapted to conduct image processing of an image formed by and output from the first imaging means, then after detecting information contained in the invisible light of the predetermined wavelength band that is projected onto a target subject in the image, compute a first distance to the subject, and output the first distance information;
stereo distance computation means adapted to conduct stereo image processing of both the image formed by and output from the first imaging means, and an image formed by and output from the second imaging means, then compute a second distance to the subject, and output the second distance information;
distance computation control means adapted to control computation conditions used for the invisible-light-aided distance computation means and the stereo distance computation means to conduct the respective computations; and
timing control means adapted to control a period during which the invisible-light projection means projects the invisible light, imaging by the first imaging means, acquired-image output timing thereof, imaging by the second imaging means, acquired-image output timing thereof, distance computation timing of the invisible-light-aided distance computation means, and distance computation timing of the stereo distance computation means;
wherein, under the timing control of the timing control means,
the invisible-light projection means projects the invisible light in predetermined timing;
the invisible-light-aided distance computation means conducts a distance computation process using the image that the first imaging means acquires and outputs in the timing that the invisible light is being projected; and
the stereo distance computation means conducts a distance computation process using the images that both of the first imaging means and the second imaging means acquire and output in the timing that the invisible light is not being projected.

15. The distance measuring device according to claim 14, further comprising:
subject tracking means adapted to detect and track a specific subject using at least one of the image that the first imaging means acquires, the image that the second imaging means acquires, the distance information that the invisible-light-aided distance computation means outputs, and the distance information that the stereo distance computation means outputs; wherein
the distance computation control means selects using one or both of the invisible-light-aided distance computation means and the stereo distance computation means, depending upon tracking results on the specific subject that are output from the subject tracking means; and
the timing control means controls operation timing of the relevant distance computation means according to results of the selection by the distance computation control means.

16. The distance measuring device according to claim 1, further comprising:
an image output section configured to output to an image display medium the acquired image that the second imaging means outputs;
wherein the second imaging means conducts a different kind of camera signal processing upon the stereo distance computation means and the image output section each, and outputs generated images.

17. A distance measuring device comprising:
first imaging means having spectral response characteristics in a wavelength band of visible light and in a predetermined wavelength band of invisible light;
second imaging means having spectral response characteristics in the wavelength band of the visible light, the second imaging means having no spectral response characteristics in the predetermined wavelength band of the invisible light;
invisible-light-aided distance computation means adapted to conduct image processing of an image formed by and output from the first imaging means, then after detecting information contained in the invisible light of the predetermined wavelength band that is projected onto a target subject in the image, compute a first distance to the subject, and output the first distance information;
stereo distance computation means adapted to conduct stereo image processing of both the image formed by and output from the first imaging means and an image formed by and output from the second imaging means, then compute a second distance to the subject, and output the second distance information;
distance computation control means adapted to control computation conditions used for the invisible-light-aided distance computation means and the stereo distance computation means to conduct the respective computations; and
distance computation information calibration means adapted to calculate calibration information that the patterned-light-aided distance computation means and the stereo distance computation means are to use for computing distance information, and store the calculated calibration information; wherein
the distance computation control means sets a distance measuring range of the invisible-light-aided distance computation means and a distance measuring range of the stereo distance computation means so that the distance measuring ranges partly overlap; and
on a basis of the two sets of distance information obtained during the computations in the overlapping distance measuring ranges by the patterned-light-aided distance computation means and the stereo distance computation means, the distance computation information calibration means calculates the calibration information that either the invisible-light-aided distance computation means or the stereo distance computation means is to use for computing the distance information, and stores the calculated calibration information.

18. A distance measuring device comprising:
first imaging means having spectral response characteristics in a predetermined wavelength band of invisible light, the first imaging means having no spectral response characteristics in a wavelength band of visible light;
second imaging means having spectral response characteristics in the wavelength band of the visible light, the second imaging means having no spectral response characteristics in the predetermined wavelength band of the invisible light;
invisible-light projection means adapted to project the invisible light of the predetermined wavelength band in an angle-of-view range of the first imaging means;
invisible-light-aided distance computation means adapted to conduct image processing of an image formed by and output from the first imaging means, then compute a first distance to a target subject on a basis of information contained in the invisible light of the predetermined wavelength band that is projected onto the subject detected from the image, and output the first distance information;
stereo distance computation means adapted to conduct stereo image processing of both the image formed by and output from the first imaging means and an image formed by and output from the second imaging means, then compute a second distance to the subject, and output the second distance information; and
distance computation control means adapted to control computation conditions used for the invisible-light-aided distance computation means and the stereo distance computation means to conduct the respective computations.

19. A distance measuring device comprising:
first imaging means having spectral response characteristics in a wavelength band of visible light and in a predetermined wavelength band of invisible light;
second imaging means having spectral response characteristics in the wavelength band of the visible light and in the predetermined wavelength band of the invisible light;
invisible-light projection means adapted to project the invisible light of the predetermined wavelength band in an angle-of-view range of the first imaging means;
invisible-light-aided distance computation means adapted to conduct image processing of an image formed by and output from the first imaging means, then compute a first distance to a target subject on a basis of information contained in the invisible light of the predetermined wavelength band that is projected onto the subject detected from the image, and output the first distance information;
stereo distance computation means adapted to conduct stereo image processing of both the image formed by and output from the first imaging means and an image formed by and output from the second imaging means, then compute a second distance to the subject, and output the second distance information; and
distance computation control means adapted to control computation conditions used for the invisible-light-aided distance computation means and the stereo distance computation means to conduct the respective computations.

20. A distance measuring device comprising:
first imaging means having spectral response characteristics in at least a wavelength band of visible light;
second imaging means having spectral response characteristics in at least a predetermined wavelength band of invisible light;
invisible-light projection means adapted to project the invisible light of the predetermined wavelength band in an angle-of-view range of the first imaging means;
invisible-light-aided distance computation means adapted to conduct image processing of an image formed by and output from the first imaging means, then compute a first distance to a target subject on a basis of information contained in the invisible light of the predetermined wavelength band that is projected onto the subject detected from the image, and output the first distance information;
stereo distance computation means adapted to conduct stereo image processing of both the image formed by and output from the first imaging means and an image formed by and output from the second imaging means, then compute a second distance to the subject, and output the second distance information; and
distance computation control means adapted to control computation conditions used for the invisible-light-aided distance computation means and the stereo distance computation means to conduct the respective computations.
